(19) United States
(12) Patent Application Publication
(10) Pub. No.: US 2014/0090622 A1
(43) Pub. Date: Apr. 3, 2014

(54) INTERNAL COMBUSTION ENGINE

(71) Applicant: Harold Cranmer Seelig, S Chesterfield, VA (US)

(72) Inventor: Harold Cranmer Seelig, S Chesterfield, VA (US)

(21) Appl. No.: 13/631,082

(22) Filed: Sep. 28, 2012

(51) Int. Cl. F02P 3/00; F02B 17/00

(52) U.S. Cl. 123/298

(57) ABSTRACT

An internal combustion engine electrically ignites most of the fuel as it is introduced into the combustion chamber. This design solves the lower efficiency of typical Otto Cycle engines by allowing the use of a full air charge for each power cycle. This design also solves the problem of heavy duty designs required for existing diesel cycle engines by allowing relatively low compression ratios and therefore lighter weight engine designs. The engine design allows a wide range of fuel combustion properties, as it avoids a dependence on flame propagation through a combustible mixture, where fuel combustion properties control evaporation, rate of flame front propagation and the like. The engine design forces the combustion to be initiated as and at the rate the fuel is introduced into the combustion chamber.

### BACKGROUND OF THE INVENTION

The present invention relates to an internal combustion engine and, more particularly, to an internal combustion engine that uses an electrical ignition in a low compression combustion chamber.

Many internal combustion engines are the Otto Cycle (fueled by gasoline, liquefied propane gas (LPG), natural gas, butane, alcohol and the like) spark ignition engines. Otto Cycle and Atkinson Cycle engines have lower efficiency of fuel conversion than diesel cycle engines, particularly at power output levels less than maximum due to a restriction of intake manifold pressure or valve timing to prevent a full air charge.

In Otto cycle and Atkinson cycle engines, fuel/air is premixed in predominantly the entire combustion volume, then a spark starts combustion. The combustion then progresses through the mixture. With a diesel cycle engine, with high air temperature from compression, fuel is introduced and begins to combust as it is heated to auto-ignition temperature by hot air then by additional heating by surrounding combusting fuel and air temperature increase by increasing pressure during the combustion.

Existing Otto Cycle engines require a narrow range of fuel combustion properties to control the combustion process to prevent undesirable operation, such as “knock”. One of these fuel properties is referred to as octane.

Diesel cycle engines are heavy designs due to the required high compression ratio to provide ignition by high air temperature. These engines require fuels with a relatively narrow range of fuel ignition and combustion properties to prevent undesirable operation. One of these fuel properties is referred to as cetane.

As can be seen, there is a need for an improved internal combustion engine that improves the efficiency of Otto Cycle engine designs by converting the designs into low compression, electrically ignited diesel cycle engine designs.

### SUMMARY OF THE INVENTION

In one aspect of the present invention, an internal combustion engine comprises a fuel source having a fuel passage permitting fuel to be injected into a combustion chamber; and one or more electrodes operable to create an electrical ignition where the fuel is injected into the combustion chamber, causing the fuel to ignite as it is injected into the combustion chamber.

In another aspect of the present invention, a method for moving a piston in a cylinder of an engine comprises delivering fuel into a combustion chamber of the cylinder; passing electricity through an air gap formed by electrodes to create an electrical ignition; and igniting the fuel as it enters the combustion chamber to move the piston in the cylinder.

These and other features, aspects and advantages of the present invention will become better understood with reference to the following drawings, description and claims.

### BRIEF DESCRIPTION OF THE DRAWINGS

FIG. 1 is a detailed cut away view of a cylinder of an internal combustion engine according to an exemplary embodiment of the present invention;

FIG. 2 is an enlarged detailed cut away view showing an electrical ignition path gap with combustion initiated as and at the rate the fuel is introduced into the combustion chamber;

FIG. 3 is a top view of an electrode used in the internal combustion engine of the present invention;

FIG. 4 is a cross-sectional view taken along line 4-4 of FIG. 3;

FIG. 5 is a detailed cut away view of a cylinder of an embodiment of an internal combustion engine according to another exemplary embodiment of the present invention;

FIG. 6 is an enlarged detailed cut away view of the cylinder shown in FIG. 5;

FIG. 7 is a perspective view showing another exemplary embodiment of the present invention;

FIG. 8 is a perspective view showing yet another exemplary embodiment of the present invention; and

FIG. 9 is a perspective view showing yet a further exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides an internal combustion engine that electrically ignites most of the fuel as it is introduced into the combustion chamber. This design solves the lower efficiency of typical Otto Cycle engines by allowing the use of a full air charge for each power cycle. This design also solves the problem of heavy duty designs required for existing diesel cycle engines by allowing relatively low compression ratios and therefore lighter weight engine designs. The engine design allows a wide range of fuel combustion properties, as it avoids a dependence on flame propagation through a combustible mixture, where fuel combustion properties control evaporation, rate of flame front propagation and the like. The engine design forces the combustion to be initiated as and at the rate the fuel is introduced into the combustion chamber.

Proper fuel/air mixture at the time of combustion in the present invention is controlled by the induction of air into the combustion volume by the incoming jet(s) (jet, spray, or the like) of fuel as a liquid, mist, vapor, gas and the like. In the present invention, combustion occurs in the volume in which the fuel/air mixture is correct for combustion allowing, at least at some engine output power levels, an empirically lean mixture. The present invention removes the dependence on a natural progression of combustion from the point or points the combustion is initiated through all of the air/fuel mixture by forcing combustion to occur at a specific position along the path of fuel introduction into the combustion chamber, as the air/fuel mixture is directed through an electrical ignition gap.

The design of the present invention, as described in greater detail below, uses a light weight design similar to typical Otto Cycle and Atkinson Cycle engines except for several differences as discussed in the following paragraphs.

In the design of the present invention, there is no restriction of air flow (no throttle plate) to control power output. Typical Otto Cycle engines and Atkinson Cycle engines use an intake manifold pressure less than maximum at all but full power settings, where the pressure is often controlled by a butterfly type valve and/or valve timing to prevent a full charge of air. In the design of the present invention, full intake pressure is used for all power levels, the same as a diesel engine at all power levels. The design of the present invention is similar to typical diesel cycle engines, except that it allows a relatively low compression ratio and the combustion process is electrically ignited rather than ignited by high air temperature provided by high compression ratio of a typical diesel cycle engine.

The present invention can use direct injection of fuel in to the combustion chamber at the approximate time of ignition. Typical Otto Cycle and Atkinson Cycle engines introduce fuel into the combustion chamber either with the intake air, or at some time prior to the ignition point in the combustion process. Typical Otto Cycle and Atkinson Cycle engines have a more-or-less uniformly mixed air/fuel charge with a more-or-less fixed ratio of fuel to air at the time combustion is initiated. A diesel engine has a full charge of air and power level is controlled by the amount of fuel injected for each power stroke. The engine of the present invention can use a full air charge with power output controlled by amount of fuel introduced, thus similar to a diesel cycle engine.

The fuel used in the engine of the present invention can be ignited electrically as it is introduced into the combustion chamber, before it mixes completely with the air in the combustion chamber. This design allows use of a wide range of fuel types.

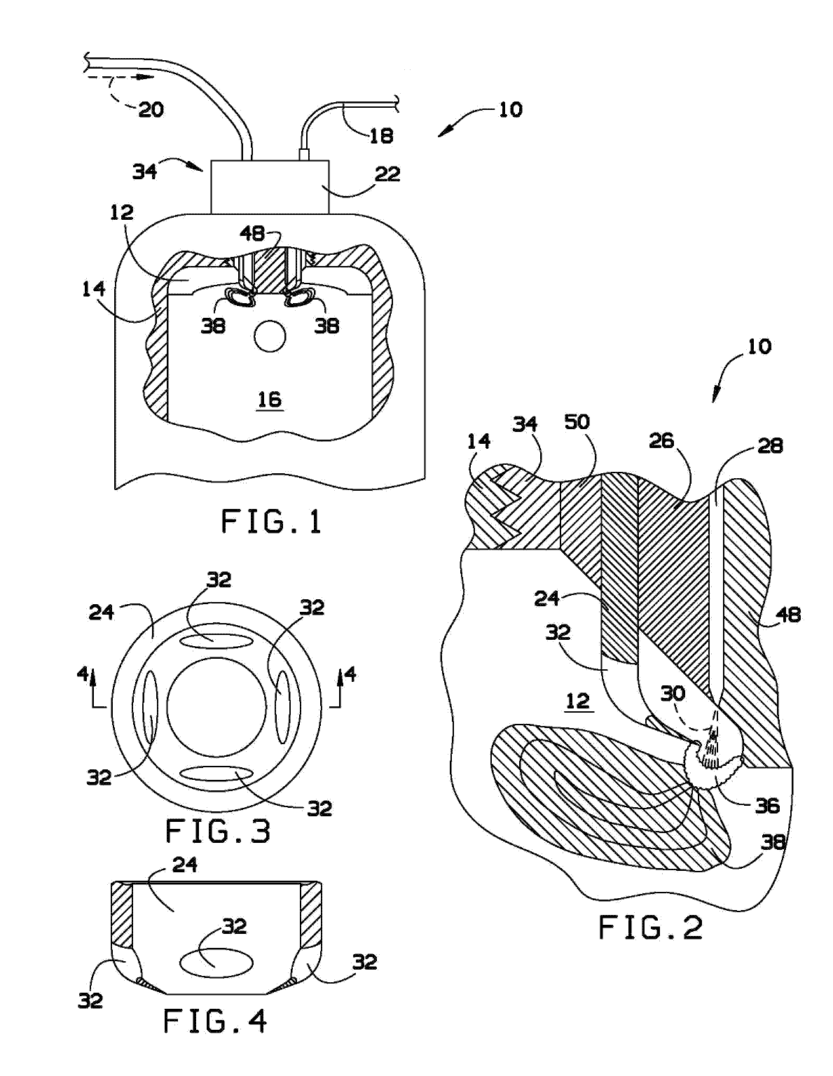

Referring to FIGS. 1 through 4, an engine design 10 can include a combustion chamber 12 within a cylinder 14 of an engine. A piston 16 can be driven by the combustion of fuel introduced into the combustion chamber 12. Fuel can be delivered to the engine through a fuel line 20. Electrical ignition can be controlled through an ignition wire 18 and electrical return path 22 within the ignition and fuel plug 34.

Referring specifically to FIG. 2, fuel flow can travel through a fuel passage 28 to be delivered as injected fuel 30. A circular shaped electrode 24 can be disposed with appropriate electrical insulation 26 to separate the electrode 24 from a central electrode 48. Additional electrical insulation 50 can be optionally disposed to separate the electrode 24 from the ignition and fuel plug 34. The electrode 24 can cause combusting fuel 38 as it passes through an electrical ignition 36. Holes 32 can be formed in the electrode 24 to permit air flow.

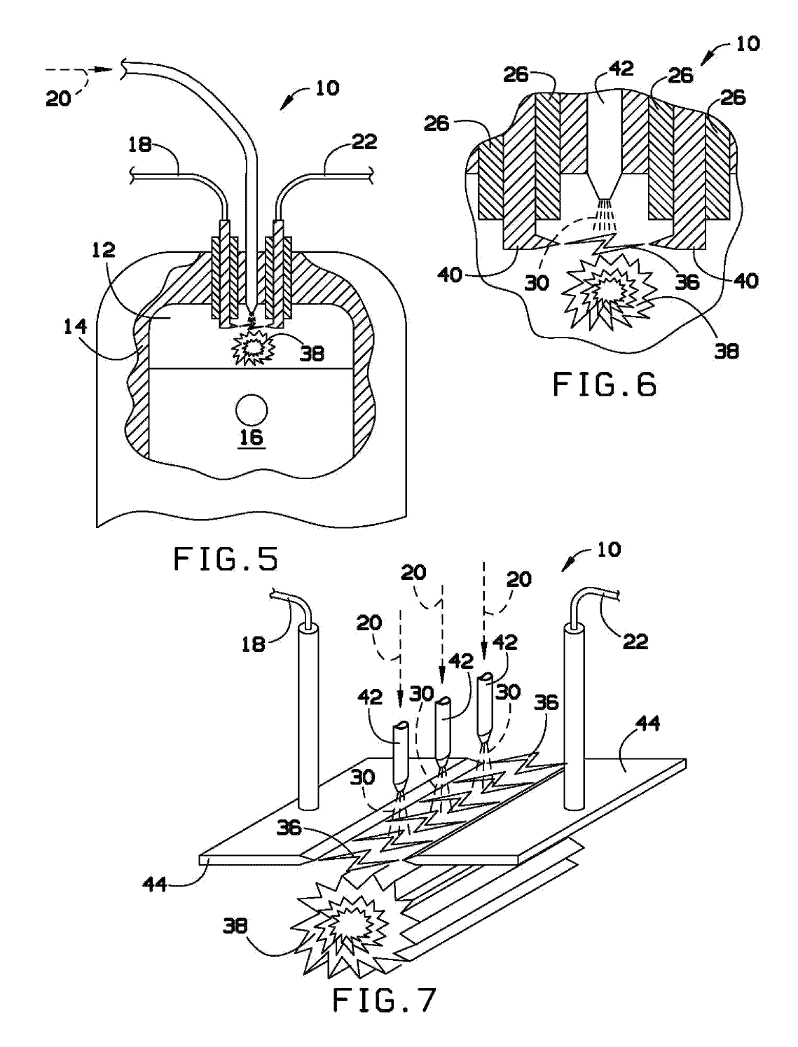

Referring now to FIGS. 5 and 6 in an alternate design, a fuel injection nozzle 42 can be centrally disposed between two point-type electrodes 40 that cause an electrical ignition 36 therebetween. In the design shown in FIGS. 5 and 6, a single fuel injection nozzle 42 can be disposed, however, in some embodiments, as shown in FIG. 7, plate-type electrodes 44 can be disposed and a plurality of fuel injection nozzles 42 can deliver fuel between the plate-type electrodes 44. Regardless of the design, the engine of the present invention electrically ignites most of the fuel/air mixture as it is introduced into the combustion chamber, as opposed to typical engines where a natural progression of combustion from the point or points the combustion is initiated through all the air/fuel mixture.

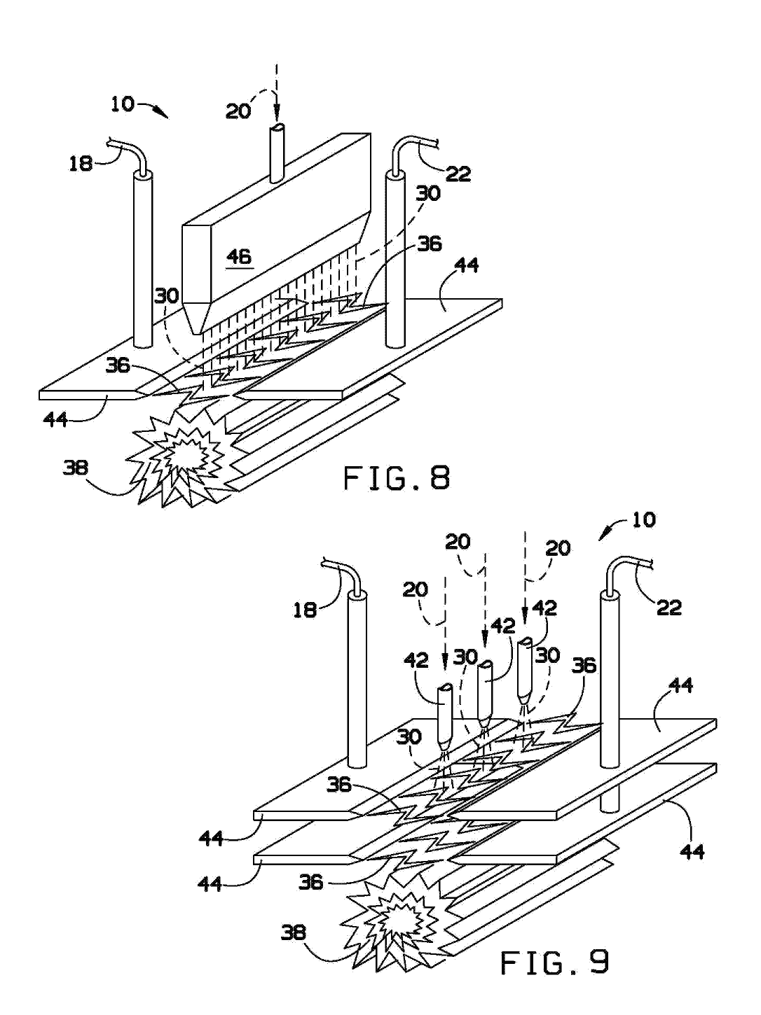

Referring now to FIG. 8, in another embodiment of the present invention, a slot injection nozzle 46 can be used to deliver fuel 30 for combustion between plate-type electrodes 44.

In FIG. 9, multiple plate-type electrodes 44 can be disposed in series to provide multiple zones of electrical ignition 36. Multiple fuel injection nozzles 42 can deliver fuel 30 into the electrical ignition 36, as shown in FIG. 9. Other fuel injection methods could be used as well, such as the slot injection nozzle 46 shown in FIG. 8 could be used with the multiple plate-type electrodes 44 shown in FIG. 9.

The electronic ignition device can take various forms and designs. The above description and Figures show, for example, circular, point-type and plate-type electrodes. The electrodes can be powered by alternating current (AC) or direct current (DC) igniters which has at least one air gap in the electrical current flow path inside the combustion chamber and is capable of igniting a flow of fuel as it enters a combustion chamber. If DC ignition, the ignition may be a single pulse at constant voltage or constant current, or a single pulse with varying voltage and/or current, or a series of pulses of constant or varying voltages or currents or any combination thereof. If AC ignition, the ignition may be at a single frequency or range of frequencies from very low frequency through extremely high frequency or any combination of frequencies, as is or may become technically possible, with the waveform of the voltage and/or current flow being symmetrical or non-symmetrical about zero volts and/or zero amperes of current flow. AC ignition voltage and/or current cycles may each be either symmetric or non-symmetric, or any combination of symmetric and non-symmetric cycles of smooth and/or abrupt waveforms.

Existing Otto Cycle engines and Atkinson Cycle engines use single or multiple electric arcs to ignite a fundamentally ‘pre-mixed’ or not completely mixed fuel/air mixture. In the present invention, the electrical ignition device will promote burning of the fuel by exposure of most of the incoming fuel stream/mist/vapor directly to the high temperature caused by the electrical ignition, igniting the fuel as it is introduced.

The fuel injection system of the present invention can be capable of delivery of fuel into the combustion chamber that is timed in conjunction with the electrical ignition device. The pattern of fuel injection and electrical ignition (timing and/or geometric configuration) may be a single pulse of each of some duration or multiple pulses of some duration, starting before, during or after the end of the compression cycle (top dead center) and ending before the end of the expansion portion of the running cycle.

It should be understood, of course, that the foregoing relates to exemplary embodiments of the invention and that modifications may be made without departing from the spirit and scope of the invention as set forth in the following claims.

What is claimed is:

1. An internal combustion engine comprising:
a fuel source having a fuel passage permitting fuel to be injected into a combustion chamber; and
one or more electrodes operable to create an electrical ignition where the fuel is injected into the combustion chamber, causing the fuel to ignite as it is injected into the combustion chamber.

2. The internal combustion engine of claim 1, wherein the electrode is a circular electrode forming the electrical ignition about a diameter of the circle electrode.

3. The internal combustion engine of claim 1, wherein the electrode is a point electrode forming the electrical ignition between two opposed points with an air gap therebetween.

4. The internal combustion engine of claim 1, wherein the electrode is a plate-type electrode forming the electrical ignition between two lines formed along edges of opposed plates.

5. The internal combustion engine of claim 4, wherein the electrode includes multiple plate-type electrodes disposed in series with each other.

6. The internal combustion engine of claim 1, wherein the fuel is injected into the combustion chamber with a single fuel injection nozzle.

7. The internal combustion engine of claim 1, wherein the fuel is injected into the combustion chamber with multiple fuel injection nozzles.

8. The internal combustion engine of claim 1, wherein the fuel is injected into the combustion chamber with a slot injection nozzle.

9. A method for moving a piston in a cylinder of an engine, the method comprising:
delivering fuel into a combustion chamber of the cylinder;
passing electricity through an air gap formed by electrodes to create an electrical ignition; and
igniting the fuel as it enters the combustion chamber to move the piston in the cylinder.

10. The method of claim 9, further comprising delivering fuel from multiple fuel injectors through the electrical ignition created by the electrodes.
